(19) United States
(12) Patent Application Publication
(10) Pub. No.: US 2014/0226633 A1
(43) Pub. Date: Aug. 14, 2014

(54) Method and Apparatus for Code Activation, Computer Program and Storage Medium Thereof

(71) Applicants: Zhixun Tang, Beijing (CN); Xie Li, Beijing (CN); Liang Zhuang, Beijing (CN)

(72) Inventors: Zhixun Tang, Beijing (CN); Xie Li, Beijing (CN); Liang Zhuang, Beijing (CN)

(73) Assignee: ST-ERICSSON SA, Plan-les-Ouates (CH)

(21) Appl. No.: 14/342,763

(22) PCT Filed: Sep. 27, 2011
(86) PCT No.: PCT/CN2011/080230

§ 371 Date: Mar. 4, 2014

(51) Int. Cl. H04J 13/00; H04B 1/707

(52) U.S. Cl. CPC H04J 13/0077; H04B 1/707
USPC 370/335

(57) ABSTRACT

This invention relates to a method and an apparatus for code activation, and a computer program and a storage medium thereof. A combined channel impulse response for each code is calculated based on a channelization code, a scrambling code and a channel impulse response corresponding to the code; a statistical result of the correlations between each interference code and all user codes is obtained; an active interference code number is determined; the determined number of interference codes, are activated, wherein a selection of which interference codes to activate is based on the statistical result. In some embodiments of this invention, the interference codes having a close correlation with the user codes may be selected to be activated, thereby the performance of joint detection is improved. In some embodiments of this invention, the complexity of the subsequent joint detection will be remarkably reduced on the premise of ensuring the performance of the joint detection.

### FIELD OF THE INVENTION

This invention relates to wireless communication technology, in particular to a method and an apparatus for code activation, a computer program and a storage medium thereof.

### DESCRIPTION OF THE PRIOR ART

In a Direct Sequence-Code Division Multiple Access (DS-CDMA) communication system, e.g., Time-Division Synchronization Code Division Multiple Access (TD-SCDMA) wireless communication system, a neighbor cell may use the same frequency point of carrier frequency as that of a current cell so as to save frequency resource and improve system throughput. In such a wireless communication system, because the carrier frequency of the neighbor cells may be the same as that of a current cell, the received signal processed by a terminal RF portion may include an intra-frequency signal of the neighbor cells, which will cause interference on useful signals for the current cell.

Spreading of data may consist of two operations. One is channelization and the other is scrambling. First, each data symbol is spread with a channelization code. The resultant sequence is then scrambled by a scramble code. The channelization code may take the form of orthogonal Variable Spreading Factor (OVSF) code in a TD-SCDMA system. Because the scramble code for a cell is the same, while the channelization codes for different users belonging to the cell are different, the channelization code used by a user can be referred to as a user code and the channelization code causing interference with user codes can be referred to as an interference code. Regarding more detailed explanation on all sorts of codes, please refer to 3GPP TS 25.223 V5.3.0.

In the current wireless communication system using coherent demodulation technology, when the received signal is interfered by the intra-frequency signal from a neighbor cell, both user codes and interference codes will be introduced into a joint detector for joint detection. When a total number of the interference codes and the user codes is larger than the capacity of the joint detector (i.e., the maximum number of codes supported by the joint detector), the joint detector will activate parts of the codes and abandon some of the codes that are not activated, so as to ensure that the total number of codes does not exceed the capacity of the joint detector. Then, the joint detector will perform matched filtering and equalization.

Therefore, there exists a need to select appropriate codes to activate for the purpose of joint detection so as to improve the reception performance of a terminal receiver.

### SUMMARY OF THE INVENTION

In various aspects, this invention provides a method and an apparatus for code activation, a computer program and a storage medium thereof. In accordance with the embodiments, an interference code to activate may be selected based on a statistical result of correlations between an interference code and all user codes, and then an interference code having a close correlation with the user codes is selected, so as to provide more useful information in joint detection and to improve performance of the joint detection.

In some embodiments of the invention, a predetermined number of the statistical results may be selected, in a descending order, among all statistical results. Then active interference codes corresponding to the selected statistical results may be determined as the interference codes to activate.

In some embodiments of this invention, a sum value and/or mean value and/or maximum value of the correlations between each interference code and all user codes may be used as the statistical result so as to reflect the correlations between the interference codes and the user codes.

In some embodiments of this invention, the number of the interference codes to activate may be determined directly based on a difference value obtained by subtracting the number of the user codes from the capacity of the joint detector, thereby to simplify the calculation.

In some embodiments of this invention, the number of the interference codes to activate may be determined based on a fluctuation of the correlations between the interference codes and all the user codes. When the fluctuation is big, the total number of the active codes may be reduced, and on the premise of ensuring the performance of the joint detection, the complexity of a subsequent joint detection will be reduced remarkably.

Of course, this invention is not limited to the above-mentioned features and advantages. In fact, a person skilled in the art will find the other features and advantages after reviewing the embodiments and drawings below.

### BRIEF DESCRIPTION OF THE DRAWINGS

FIG. 1 is schematic view showing the position of an apparatus for code activation according to some embodiments of this invention in the joint detection.

FIG. 2 is a flow chart showing a method for code activation according to some embodiments of this invention.

FIG. 3 is a schematic view showing how to calculate a combined channel impulse response of each code according to some embodiments of the invention;

FIG. 4 is a schematic view showing how to calculate the correspondence between user codes and interference codes according to some embodiments of the invention;

FIG. 5 is a schematic view showing another embodiment of Step 24 according to an embodiment of the invention;

FIG. 6 is a schematic view showing the structure of the apparatus for code activation according to some embodiments of this invention.

FIG. 7 is a schematic view showing a stimulation platform used in some embodiments of this invention.

FIG. 8 is a schematic view showing the performance stimulation result of the joint detection after the implementation of the method according to some embodiments of this invention.

### DETAILED DESCRIPTION OF THE PREFERRED EMBODIMENTS

This invention provides a method and an apparatus for code activation, a computer program and a storage medium thereof, which can select an appropriate code to activate from user codes and interference codes, so as to ensure the performance of a subsequent joint detection. This invention can be adapted to all DS-CDMA communication systems. In order to enable a person skilled in the art to understand this invention in a better manner, a TD-SCDMA system is used hereinafter as an example, which however cannot be regarded as limitation to this invention.

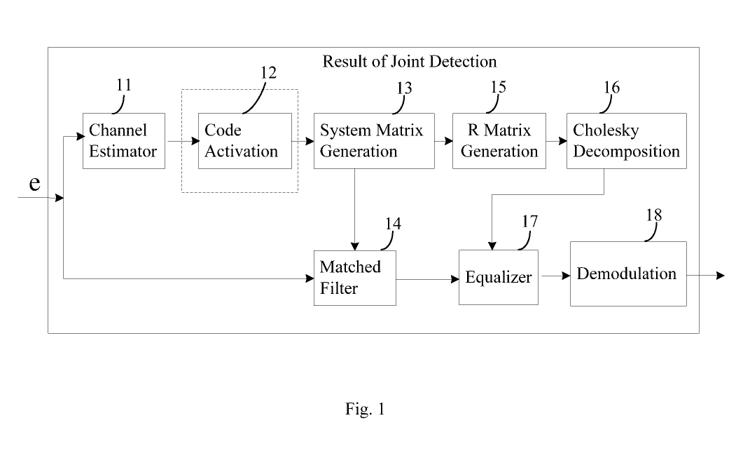

FIG. 1 is a schematic view showing the position of the apparatus for code activation according to the embodiments of this invention in the joint detection. As shown in FIG. 1, a channel estimation function may be realized by a channel estimator 11 based on the received signal. Codes to activate may be determined by a code activation unit 12, based on the channel estimation results and high-level code configuration information. A system matrix A may be generated by a system matrix generation unit 13, based on the active codes. An operation of A^{*T}e may be conducted by a matched filter unit 14, while an operation of R=(A^{*T}A+σ²I) is conducted by an R matrix generation unit 15. An operation of (LL^{*T})⁻¹ may be conducted by a Cholesky decomposition unit 16, while an operation of (LL^{*T})⁻¹A^{*T}e is conducted by an equalizer 17. And a demodulator 18 may be responsible for the demodulation of data.

As can be seen from FIG. 1, when a total number of codes including interference codes and user codes obtained from the channel estimator 11 is larger than the capacity of a joint detector, the code activation unit 12 may activate the codes so as to ensure that the number of active codes does not exceed the capacity of the joint detector. Then, the code activation unit 12 sends the information, such as the number of the active codes and the position thereof, to a system matrix generation unit 13 so as to generate a system matrix A.

For example, a joint detection may be conducted using a MMSE algorithm in a TD-SCDMA system. One of available formula for the joint detection may be as follows:

\hat{d}(A^{*T}A+σ²I)⁻¹A^{*T}e=R⁻¹A^{*T}e=(LL^{*T})⁻¹A^{*T}e

In this formula, \hat{d} represents a signal after demodulation, A represents a system matrix, e represents a receiving signal, R represents an R matrix, I represents an identity matrix, and σ represents a noise power.

The method for code activation according to the embodiments of this invention is applied to a DS-CDMA system for joint detection of two codes or more, which include one or more user codes and one or more interference codes.

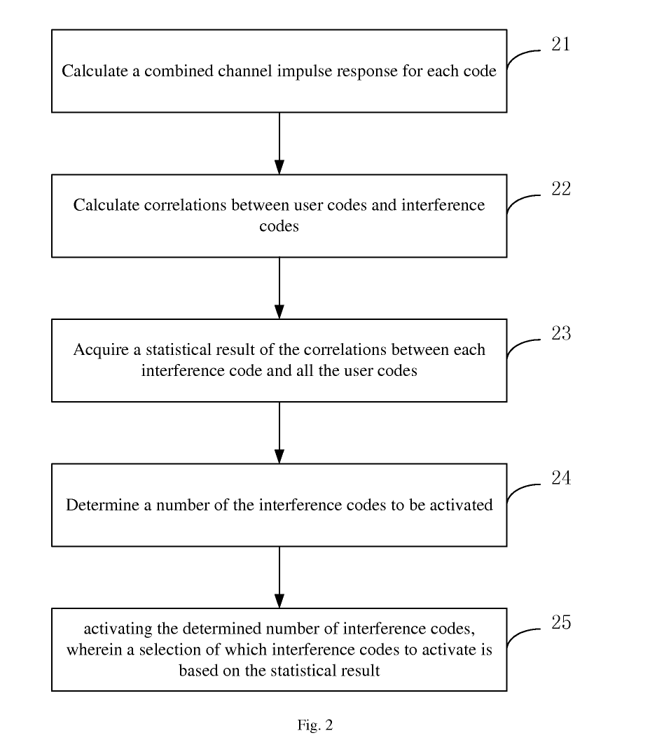

FIG. 2 is a flow chart showing the method for code activation according to the embodiments of this invention. The method may include the following steps:

Step 21, calculating, based on a channelization code, a scrambling code and a channel impulse response corresponding to each code, a combined channel impulse response for each code.

Here, “combined” means that the channelization code, the scrambling code and the channel impulse response corresponding to the code are combined, that is, for the combined channel impulse response, the influence of the channelization code and scrambling code corresponding to the codes on the channel impulse response corresponding to the codes is taken into consideration.

Step 22, calculating, based on the combined channel impulse response, correlation between each user code and each interference code.

Step 23, acquiring a statistical result of the correlation between each interference code and all the user codes.

Step 24, determining the number of active interference codes, wherein the number of active interference codes represents the number of the interference codes to activate.

Step 25, activating the determined number of interference codes, wherein a selection of which interference codes to activate is based on the statistical results.

In above Step 25, the following may be included: selecting, in a descending order, the statistical results of the number of active interference codes; and determining interference codes corresponding to the selected statistical results as the interference codes to activate.

Also in above Step 25, selecting, in an ascending order, the statistical results of the number of active interference codes; determining interference codes corresponding to the selected statistical results as the interference codes to activate, when a different calculation formula has been employed.

In Step 21, a communication device (e.g., a user equipment) calculates the combined channel impulse response for each code, including each user code and each interference code. The user code is a code assigned to the communication device by a current cell which is a serving cell for the communication device. The interference code may include the code assigned by the current cell to other communication devices, as well as the code of a neighbor cell that has an intra-frequency as the current cell.

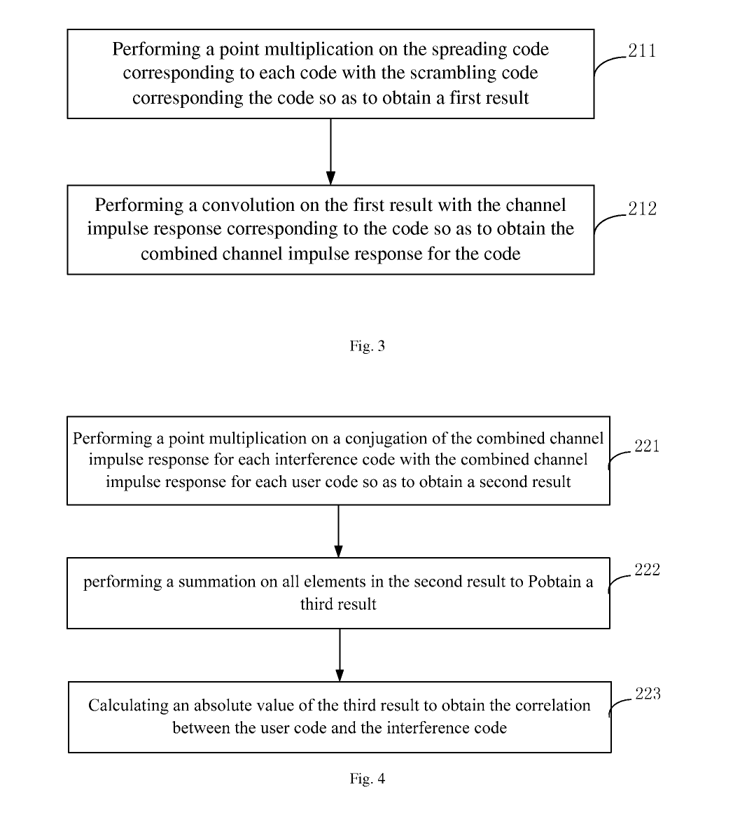

As can be seen from FIG. 3, calculating the combined channel impulse response for each code may include: Step 211, performing a point multiplication on the channelization code corresponding to each code with the scrambling code corresponding the code so as to obtain a first result; and Step 212, performing a convolution on the first result with the channel impulse response corresponding to the code so as to obtain the combined channel impulse response for the code.

Here, the channelization code and the scrambling code may both be represented by vectors, and so are the first result and the combined channel impulse response.

It can therefore be seen that, in Step 21, the channel impulse response for the code is introduced into the combined channel impulse response so that the combined channel impulse response can reflect the power of the code.

In Step 22, it may be calculated, with respect to each user code, the correlation between the user code and each interference code. As can be seen from FIG. 4, calculating the correlation may include: Step 221, performing a point multiplication on a conjugation of the combined channel impulse response for each interference code with the combined channel impulse response for each user code so as to obtain a second result which may also be a vector; Step 222, performing a summation on all elements in the second result to obtain a third result; and Step 223, calculating an absolute value of the third result to obtain the correlation between the user code and the interference code.

The correlation reflects a degree of association between a single user code and a single interference code. The bigger the correlation is, the closer the relationship between the interference code and the user code is.

Other methods may also be used for calculating the correlation in this embodiment. For example, in Step 223, after the absolute value of the third result is obtained, the absolute value can be further divided by (W+Q−1), and the obtained result is used as the correlation between the user code and the interference code. Here, W represents a window length of a channel impulse response window, and Q represents a spreading factor.

In Step 23, the statistical result may particularly be a sum value of the correlations between each interference code and all the user codes, or a mean value of the correlations between each interference code and all the user codes, or a maximum value of the correlations between each interference code and all the user codes.

For example, in Step 22, with respect to each interference code, the correlation between the interference code and each user code is calculated in this embodiment. Thus, a sum value of the correlation between the interference code and all the user codes is obtained as a statistical result by performing summation on the correlations between the interference code and all the user codes. The sum value reflects the associations between the interference code and all the user codes. Obviously, the bigger the sum value is, the closer the relationships between the interference code and all the user codes are, and the more valuable the interference code is in the joint detection.

Similarly, the mean value or the maximum value of the correlations between each interference code and all the user codes will alike reflect the degree of the relationships between the interference code and all the user codes, and will also be used as the statistical result.

In Step 24, considering the capacity of the joint detector, the number of active interference codes should typically not exceed a difference value obtained by subtracting the number of user codes from the capacity. Optionally, the number of active interference codes can be obtained in this embodiment by calculating the difference value between the maximum number of codes supported by the joint detector and the number of user codes. Thus, the final number of codes to activate is equal to the capacity of the joint detector.

Above Steps 21-25 may be realized by the code activation unit 12. In Step 25, all the user codes may further be activated so that the total number of final active codes is equal to (or less than) the capacity of the joint detector. Then, the total number of final active codes and locations of the active codes are sent to a system matrix generation unit 13. The system matrix generation unit 13 generates a system matrix based on the total number of final active codes and the locations of the active codes.

After the channel estimation and code activation, the system matrix A can be constructed as:

$$A = [ \begin{matrix}B B & 0 \\ 0 & B\end{matrix} ]$$

Where, the system submatrix B is shown as following:

$$B = [ \begin{matrix}{b}_{1}^{( 1 )} & {b}_{1}^{( 2 )} & … & {b}_{1}^{( K )} \\ {b}_{2}^{( 1 )} & {b}_{2}^{( 2 )} & … & {b}_{2}^{( K )} \\ ⋮ & ⋮ & … & ⋮ \\ {b}_{Q}^{( 1 )} & {b}_{Q}^{( 2 )} & … & {b}_{Q}^{( K )} \\ {b}_{Q + 1}^{( 1 )} & {b}_{Q + 1}^{( 2 )} & … & {b}_{Q + 1}^{( K )} \\ ⋮ & ⋮ & … & ⋮ \\ {b}_{Q + W - 1}^{( 1 )} & {b}_{Q + W - 1}^{( 2 )} & … & {b}_{Q + W - 1}^{( K )}\end{matrix} ]$$

Where, the column vector b^{(k)} corresponding to the kth code is shown as following:

b^{(k)}=[b₁^{(k)},b₂^{(k)} . . . b_{Q+W-1}^{(k)}]′=v^{(k)}*h^{(k)}k=1, . . . ,K

where,

v^{(k)} is a dot product of a channelization code and a scrambling code;

h^{(k)} is a channel estimation corresponding to an active channelization code;

K is a number of the codes;

W is a length of a system channel impulse response window;

Q is a system spreading factor.

As can be seen from the above steps, the correlations between the interference codes and each user code may be taken into consideration in this embodiment when activating the interference codes. In other words, the interference codes to activate finally are closely associated with the user codes, thus it is able to ensure the performance of the joint detection. Moreover, when calculating the combined channel impulse response for the codes, the channel impulse response corresponding to each code is introduced so as to sufficiently take the power of each code into consideration. Thus, the correlation between the codes calculated based on the combined channel impulse response for the codes reflects not only the degree of association between the codes but also the power of the codes. That is, the correlation is correlated positively with the degree of association between the codes, as well as with the power of the codes. Finally, the active interference codes may be selected based on the sum value and/or mean value and/or maximum value of the correlations are provided with more useful information, and the performance of the joint detection will be improved when these active interference codes are used for the joint detection as compared to other ways of code activation/selection.

In Step 24, the number of active interference codes is determined in this embodiment according to the capacity of the joint detector, and the number of final active codes is typically equal to the capacity of the joint detector. After study, the inventors find that, in some cases, the number of active codes may be reduced by neglecting some interference codes, thereby to reduce the complexity of the subsequent joint detection. The inventors also find that, after some of the interference codes are neglected, the performance of the joint detection will not be degraded but rather be improved.

In another preferred embodiment of Step 24, when determining the number of active interference codes, an appropriate number of active interference codes may be determined according to the fluctuation of the correlations between the user codes and each interference code. To be specific, a small number of interference codes which are activated may be selected when the fluctuation is big, and a large number of interference codes which are activated may be selected when the fluctuation is small.

For example, if the fluctuation between the user codes and each interference code is big, it means there is a great difference in the correlations between the user codes and each interference code, and if the fluctuation between the user codes and each interference code is small, it means there is a small difference in the correlations between the user codes and each interference code. The greater difference between the correlations there is, the more correlations with small values there usually are. And the interference codes corresponding to these correlations with small values are generally free codes without data.

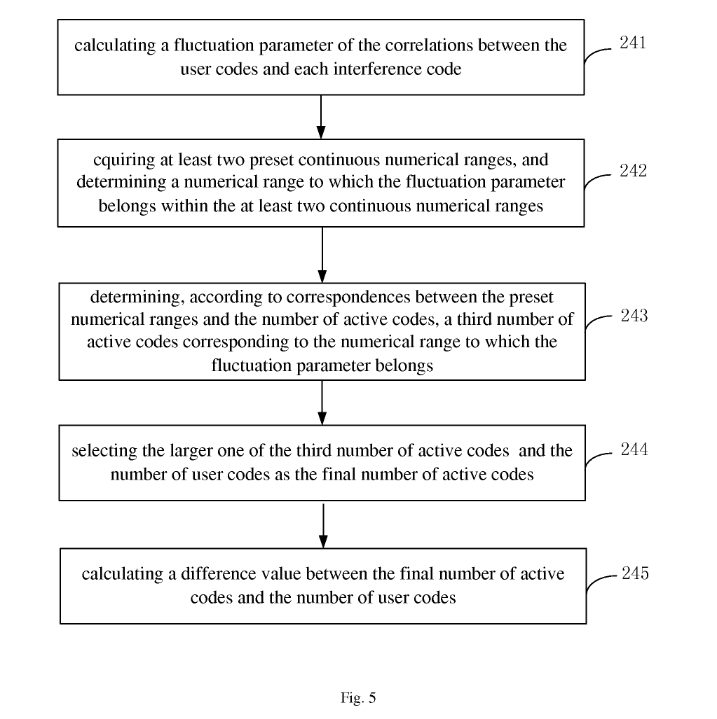

Therefore, another embodiment of Step 24 is provided, As can be seen from FIG. 5, which may include the following steps:

Step 241, calculating a fluctuation parameter of the correlations between the user codes and each interference code.

Step 242, acquiring at least two preset continuous numerical ranges, and determining a numerical range to which the fluctuation parameter belongs within the at least two continuous numerical ranges. The at least two continuous numerical ranges may be obtained by dividing a value range of the fluctuation parameter, and the numerical ranges are typically not overlapped with each other.

Step 243, determining, according to correspondences between the preset numerical ranges and the number of active codes, a third number of active codes corresponding to the numerical range to which the fluctuation parameter belongs. In the correspondences, when the fluctuation parameter in a first numerical range is larger than that in a second numerical range, a first number of active codes corresponding to the first numerical range is less than or equal to a second number of active codes corresponding to the second numerical range. In addition, in the correspondences, the number of active codes corresponding to each numerical range is less than or equal to the maximum number of codes supported by the joint detection.

Step 244, selecting the larger one of the third number of active codes and the number of user codes as the final number of active codes, so as to ensure that all the user codes are to activate.

Step 245, calculating a difference value between the final number of active codes and the number of user codes, to obtain the number of active interference codes.

It can be understood that, although being indicated by the words “first”, “second” and “third”, the units are not restricted by these words, which are merely used to differ one unit from the other. For example, with departing from the teaching of this disclosure, the first fluctuation parameter may also be called as a second fluctuation parameter, and similarly the first number of active codes may also be called as a second number of active codes.

Here, the correspondences between the numerical ranges and the number of active codes are preset, and can be adjusted dynamically so that the number of active codes determined based on the correspondence not only can reduce the complexity of the joint detection but also can ensure the performance thereof. Such a dynamical adjustment may be performed in a manner of determining the active codes and stimulating the joint detection according to different correspondences, and selecting a correspondence satisfying certain requirements according to the simulation results.

In Step 241, when calculating the fluctuation parameter of the correlations between the user codes and each interference code, any one of the user codes may be selected from all the user codes, e.g., a first user code, and then the fluctuation of the correlations between the selected user codes and each interference code is calculated so as to obtain the fluctuation parameter.

Of course, when calculating the first fluctuation parameter in Step 241, more user codes may be taken into consideration than above. At this time, at least two user codes may be selected from all the user codes, and the correlations between the at least two user codes and each interference code are obtained. Then, a weighted summation is performed on the correlations between the at least two user codes and each interference code, and all weighted summation results between the at least two user codes and each interference code is obtained. Finally, the fluctuation of all the weighted summation results is calculated to obtain the fluctuation parameter. Here, the fluctuation parameter may be represented by variance, standard deviation, or other variations of variance/standard deviation.

In order to facilitate understanding of a person skilled in the art, the above steps in the embodiment is further described hereinafter through an example having specific parameters and equations.

This example relates to a TD-SCDMA communication system, wherein the serving cell for a user device is represented by Scell, and there is only one neighbor cell for the user device, which is represented by Ncell, and the number of the channel impulse response window included in the channel impulse response for the serving cell is represented by Kcell. The relevant parameters for this example are listed in Table 1.

TABLE 1

| Communication System | TD-SCDMA |
|---|---|
| Number of Cells | 2 |
| Midamble ID | 52, 97 |
| Modulation Mode | QPSK |
| Spreading Factor | 16 |
| Kcell | 8 |
| Number of Transmitting Antenna | 1 |
| Number of Receiving Antenna | 1 |
| Number of Codes in Each Cell | Serving Cell: 2 |
| | Neighbor Cell: 16 |
| Codes ID in Each Cell | Serving Cell: 1, 2 |
| | Neighbor Cell: 1-16 |
| Number of Slots | 1 |

In this example, the number of user codes is 2, the number of interference codes is 16, and Kcell is 8. Thus, the window length of the channel impulse response window is 128/8=16. After a user device performs a signal estimation processing on the received signals, (2+16)=18 codes are obtained. The capacity of the joint detector is 16, thus it needs to activate the codes as follows:

1) Generating a combined channel impulse response for all the codes (including user codes and interference codes). The combined channel impulse response b^{(k)} for the k^{th} code is:

$$\begin{matrix}{b}^{( k )} = ( {b}_{1}^{( k )} , {b}_{2}^{( k )} , … , {b}_{Q + W - 1}^{( k )} ) \\ = ( {c}^{( k )} {.}^{*} {m}^{( k )} ) ⊗ {h}^{( k )} \\ = ( ( {c}_{1}^{( k )} , {c}_{2}^{( k )} , … , {c}_{Q}^{( k )} ) {.}^{*} ( {m}_{1}^{( k )} , {m}_{2}^{( k )} , … , {m}_{Q}^{( k )} ) ) ⊗ ( {h}_{1}^{( k )} , {h}_{2}^{( k )} , … , {h}_{W}^{( k )} )\end{matrix}$$

In this equation, b^{(k)} is a combined channel impulse response for the k^{th} code; c^{(k)} is a channelization code corresponding to the k^{th} code; m^{(k)} is a scrambling code corresponding to the k^{th} code; h^{(k)} is a channel impulse response corresponding to the k^{th} code; ·* is a point multiplication symbol, i.e., a correspondence point multiplication is performed on the elements in the two vectors, and the result of the point multiplication is still a vector; [symbol] is a linear convolution symbol; Q is a spreading factor; and W is a window length of the channel impulse response window. A user device may use the methods existing in the prior art to obtain the channelization code, the scrambling code and the channel impulse response corresponding to each code. A communication device may obtain the user code, the cell ID, the position of the user code, the number of the channel impulse response window Kcell included in the channel impulse response for the serving cell, and the spreading factor by receiving the signaling at the network side. In a TD-SCDMA system, a window length W of the channel impulse response window=a training sequence length/Kcell, and in this example, W=16.

2) Calculating the correlations between the user codes and the interference codes using the generated combined channel impulse response for all the codes (including user codes and interference codes), and generating a N*M dimensional correlation matrix Cor based on the calculation results of the correlations, wherein N is the number of user codes, M is the number of interference codes. In this example, N=2 and M=16. The element Cor(i,j) in the correlation matrix Cor is the correlation between the i^{th} user code and the j^{th} interference code, which is calculated by the following equation:

Cor(i,j)=abs(sum(b⁽ⁱ⁾·*b^{(j)*})),i=1,2, . . . ,N,j=1,2, . . . ,M

where sum(.) represents a summation operation for all the elements of the vector, abs(.) represents an absolute operation, and b^{(j)*} represents a conjugation of b^{(j)}.

3) Obtaining a sum value of the correlations between each interference code and all the user codes, wherein the sum value β(k) of the correlations between the k^{th} interference code and all the user codes is calculated by the following equation:

$$β ( k ) = {\sum }_{i = 1}^{N} Cor ( i , k ) , k == 1 , 2 , … , M$$

4) Determining the number of interference codes to activate in accordance with the correlation matrix Cor, and then activating all the user codes and the interference codes corresponding to the determined number of interference codes to activate.

In this example, an appropriate number of active codes is determined according to the fluctuation of the correlation between the user codes and each interference code, and then the number of active interference codes is determined.

4a) The fluctuation may be determined by defining the fluctuation parameter a which is used to represent the fluctuation of the correlation:

$$α = \frac{var ( CM )}{Mean ( CM {.}^{*} CM ) * M}$$

In the above equation, var(.) represents a variance operation, Mean(.) represents a mean value operation, and ·* represents a point multiplication operation.

In the above equation, CM is a one-dimensional vector consisting of the correlations between a certain user code and the respective interference code, e.g., a one-dimensional vector CM={Cor(1,1), Cor(1,2), . . . , Cor (1,M)} consisting of the correlations between the 1^{st} user code and the respective interference code.

It can therefore be seen that, the fluctuation parameter a in the above equation is obtained by a variation operation for the variance of the correlations between a user code (e.g., the 1^{st} user code) and the respective interference code. In this example, the fluctuation parameter may also be represented by the variance, the standard deviation or the other variations of variance/standard deviation.

Optionally, in this example, CM in the above equation may be replaced by the weighted summation result of the correlations between at least two user codes and each interference code, i.e.,

CM=A₁*CM₁+A₂*CM₂+ . . . +A_{Ns}*CM_{Ns}

where A₁+A₂+ . . . +A_{Ns}=1 and A₁, A₂, . . . , A_{N} are real numbers greater than 0, and Ns is the number of codes of the at least two user codes. Preferably, A₁, A₂, . . . , A_{Ns} are all 1/Ns.

$$\begin{matrix}\begin{matrix}{CM}_{1} = \{ Cor ( {N}_{1} , 1 ) , Cor ( {N}_{1} , 2 ) , … , Cor ( {N}_{1} , M ) \} \\ {CM}_{2} = \{ Cor ( {N}_{2} , 1 ) , Cor ( {N}_{2} , 2 ) , … , Cor ( {N}_{2} , M ) \}\end{matrix} \\ ⋯ \\ {CM}_{Ns} = \{ Cor ( {N}_{Ns} , 1 ) , Cor ( {N}_{Ns} , 2 ) , … , Cor ( {N}_{Ns} , M ) \} ,\end{matrix}$$

where Nᵢ, i=1, 2, . . . , Ns represents the i^{th} user code in the at least two user codes.

4b) In this example, after calculating the fluctuation parameter a, the number of active codes NumCodeₘₐₓ corresponding to the fluctuation parameter may be determined according to the preset correspondences. Following is an example of such correspondences:

$${NumCode}_{max} = \{ \begin{matrix}12 & α > 0.75 \\ 14 & 0.75 \geq α > 0.5 \\ 16 & α \leq 0.5\end{matrix}$$

It can be seen that, in the above correspondences, when α>0.5, the number of active codes is less than the capacity of the joint detector, thus it may be reasonable to reduce the number of final active codes and to reduce the complexity of the joint detection.

4c) Then, NumCodeₘₐₓ is compared with the number of user codes N, and the larger one is selected as the final number of active codes NumCodeₘₐₓ′: NumCodeₘₐₓ′=max(NumCodeₘₐₓ,Nᵤₛₑᵣ)

4d) A difference value between the final number and the number of user codes is calculated, thus the number of interference codes to be activate is NumCodeₘₐₓ′−N.

5) Selecting, according to the sum value β(k) of the correlations in a descending order, the sum value of the number of interference codes to activate, activating the interference codes corresponding to the selected sum value, and meanwhile activating all the user codes.

For the method and apparatus for code activation according to the embodiments of this invention, the correlations between the codes and the power of the codes are simultaneously taken into consideration during the code activation. The joint detection based on the selected active codes may improve the performance thereof. Moreover, in the embodiments of this invention, an appropriate number of active codes may also be selected according to the fluctuation of the correlations, and in some cases it is able to remarkably reduce the complexity of the joint detection, thereby to reduce the complexity of the receiver.

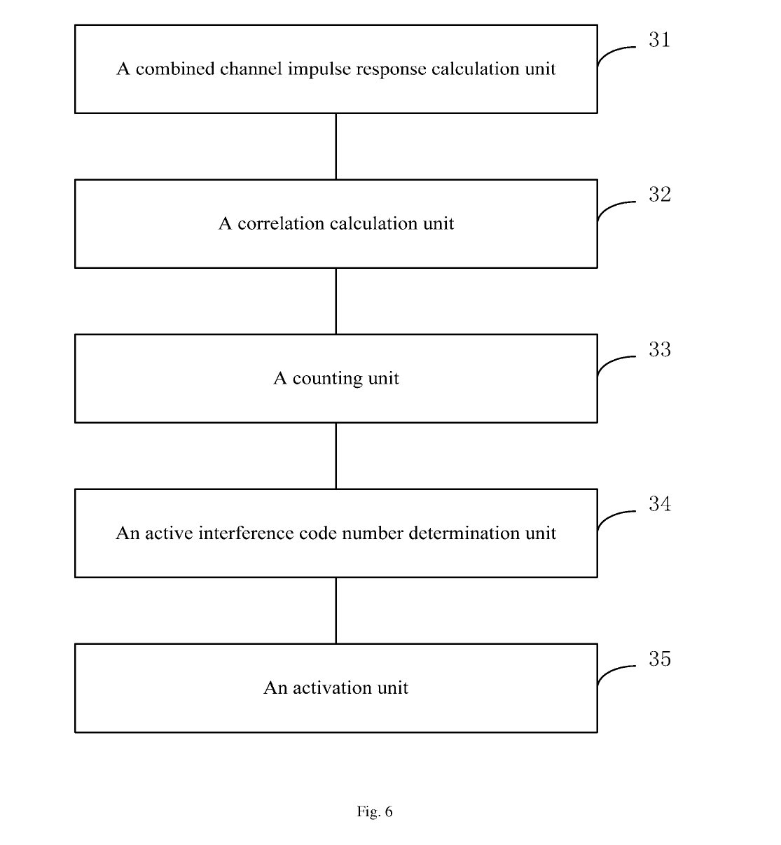

FIG. 6 is a schematic view showing the apparatus for code activation in the wireless communication system according to the embodiments of this invention. The apparatus can be embedded within the code activation unit 12 shown in FIG. 1, so as to conduct all steps shown in FIG. 2. The apparatus may include:

a combined channel impulse response calculation unit 31 arranged to calculate a combined channel impulse response for each code according to a channelization code, a scrambling code and a channel impulse response corresponding to each code;
a correlation calculation unit 32 arranged to calculate the correlations between the user codes and each interference code according to the combined channel impulse response;
a counting unit 33 arranged to obtain a statistical result of the correlations between each interference code and all the user codes;
a determination unit 34 for the number of interference codes to activate arranged to determine the number of interference codes to activate; and
an activation unit 35 arranged to activate the determined number of interference codes, wherein a selection of which interference codes to activate is based on the statistical result.

Preferably, the activation unit may include:

a selection unit arranged to select, in a descending order, the statistical results of the number of active interference codes; and a determination unit arranged to determine interference codes corresponding to the selected statistical results as the interference codes to activate.

Preferably, the combined channel impulse response calculation unit 31 may include:

a first point multiplication unit arranged to perform a point multiplication on the channelization code corresponding to each code with the scrambling code corresponding the code, so as to obtain a first result which is a vector; and
a convolution unit arranged to perform a convolution on the first result with the channel impulse response corresponding to the code, so as to obtain the combined channel impulse response for the code.

Preferably, the correlation calculation unit may include:

a second point multiplication unit arranged to perform a point multiplication on the conjugation of the combination channel impulse response for each interference code with the combined channel impulse response for each user code, so as to obtain a second result which is a vector;
a summation unit arranged to perform a summation on all the elements of the second result, so as to obtain a third result; and
an absolute value calculation unit arranged to calculate an absolute value of the third result, so as to obtain the correlation between the user code and the interference code.

In the embodiments of this invention, the statistical result may be represented in various forms. For example, the statistical result may be a sum value of the correlations between each interference code and all the user codes. The statistical result may also be a mean value of the correlations between each interference code and all the user codes. Even, the statistical result may be a maximum value of the correlations between each interference code and all the user codes.

At least two specific ways for realizing the determination unit for the number of interference codes to activate are also provided in the embodiments of this invention. As a first way, the determination unit for the number of interference codes to be activated may include a first difference value calculation unit arranged to calculate a difference value between the maximum number of codes supported by the joint detection and the number of user codes, so as to obtain the number of interference codes to activate.

As a second way, the determination unit for the number of interference codes to activate may include:

a fluctuation calculation unit arranged to calculate the fluctuation parameter of the correlations between the user codes and each interference code;
a numerical range determination unit arranged to obtain at least two preset continuous numerical ranges, and determine the numerical range to which the fluctuation parameter belongs within the at least two continuous numerical ranges, the at least two continuous numerical ranges being obtained by dividing a value range of the fluctuation parameter, and the numerical ranges being not overlapped with each other;
a determination unit for the number of codes to activate arranged to, according to the correspondences between the preset numerical ranges and the number of codes to activate, to determine a third number of active codes corresponding to the numerical range to which the fluctuation parameter belongs, and in the correspondences, when the fluctuation parameter in a first numerical range is larger than that in a second numerical range, a first number of active codes corresponding to the first numerical range being less than or equal to a second number of active codes corresponding to the second numerical range;
a first selection unit arranged to select the larger one of the third number of active codes and the number of user codes as the final number of active codes; and
a second difference value calculation unit arranged to calculate a difference value between the final number and the number of user codes, so as to obtain the number of interference codes to activate.

At least two ways for realizing the fluctuation calculation unit are provided in the embodiments of this invention.

As a preferred way, the fluctuation calculation unit may include a first calculation unit arranged to calculate the fluctuation of the correlations between any one of the user codes and each interference code, so as to obtain the fluctuation parameter of the correlations between the user code and each interference code.

As another preferred way, the fluctuation calculation unit may include:

a second selection unit arranged to select at least two user codes;
a first acquisition unit arranged to acquire the correlations between the at least two user codes and each interference code;
a summation unit arranged to perform a weighted summation on the correlations between the at least two user codes and each interference code;
a second acquisition unit arranged to acquire a weighted summation result of the correlations between the at least two codes and the respective interference code; and
a second calculation unit arranged to calculate the fluctuation of the weighted summation result, so as to obtain the fluctuation parameter of the correlations between the user codes and each interference code.

The method according to the embodiments of this invention may be carried out by means of hardware and/or software, thus the method for code activation according to the embodiments of this invention is adapted to be realized by means of processors, such as a general processor and a signal processor. The computer program may include program codes, which are stored in a computer-readable medium and can be loaded and executed via the processors so as to carry out the above-mentioned method.

For example, a computer program including instructions is provided in the embodiments of this invention. The instructions are arranged to enable the processors to execute the method according to the embodiments of this invention when being executed by a processor. Also, a storage medium for storing the computer program is provided in the embodiments of this invention.

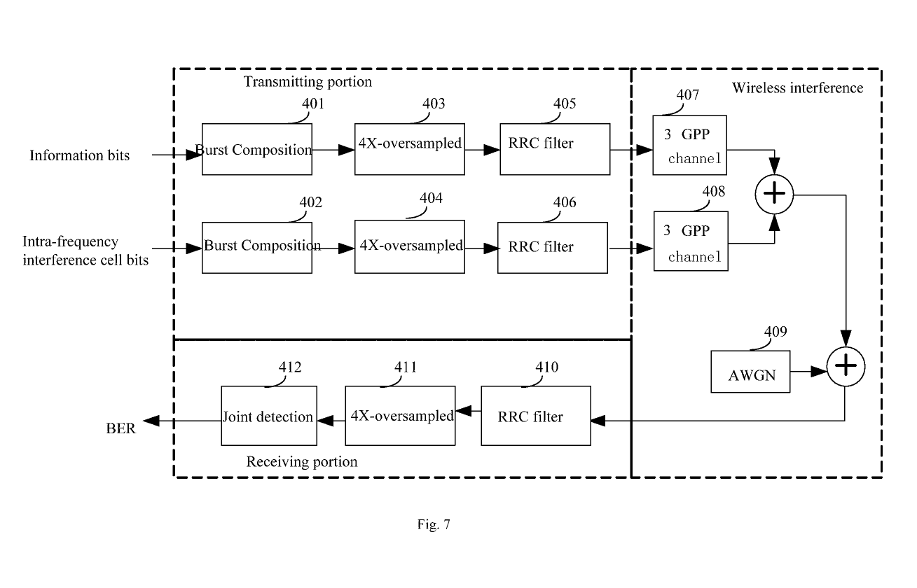

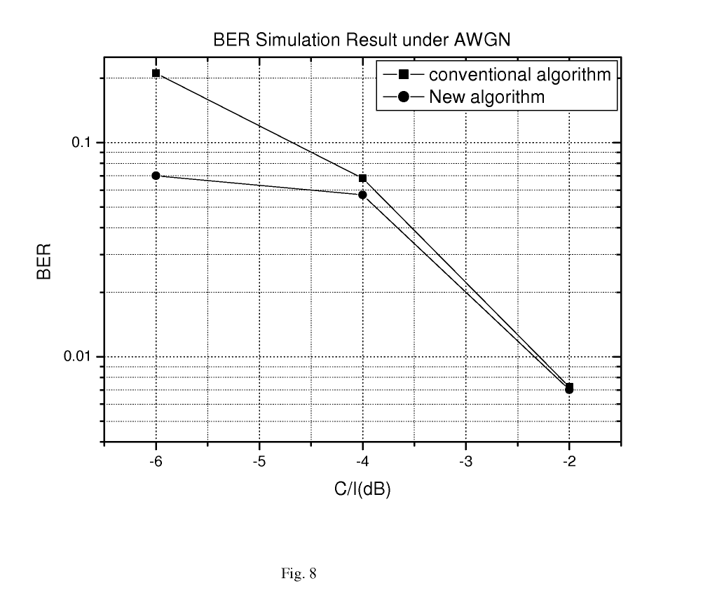

FIG. 8 shows stimulation results of a TD-SCDMA system with the stimulation parameters listed in Table 2 when using the stimulation platform as shown in FIG. 7. The simulation platform shown by FIG. 7 may include the following:

A burst composition unit 401 is configured to generate bursts based on information bits of a user. The bursts can be transformed into a roll-off pulse signal after a 4 up-over sample unit 403 and a root raised cosine chip impulse filter 405, in order better to send the resultant signal. A 3GPP signal unit 407 is configured to simulate multi-path channels, so as to realize a multi-path propagation of the roll-off pulse signal.
A burst composition unit 402 is configured to generate bursts based on bits data of an intra-frequency interference cell. The bursts can be transformed into a roll-off pulse signal after a 4 up-over sample unit 405 and a root raised cosine chip impulse filter 407, in order better to send the resultant signal. A 3GPP signal unit 408 is configured to simulate multi-path channels, so as to realize a multi-path propagation of the roll-off pulse signal.
A receiving signal can be obtained by adding the output signal from a 3GPP signal unit 407 and a 3GPP signal unit 408 to additive white Gaussian noise (AWGN) signal generated by an AWGN unit 409.
The resultant signals go through a root raised cosine chip impulse filter 410 and a 4 up-over sample unit 411 sequentially. At last, a joint detection can be performed on the signal output from the 4 up-over sample unit 411 by a joint detection unit 412, so as to obtain relevant user data.

TABLE 2

| | |
|---|---|
| Communication System | TD-SCDMA |
| Number of Cells | 2 |
| Midamble ID | 52, 97 |
| Modulation Mode | QPSK |
| Spreading Factor | 16 |
| Kcell | 8 |
| Number of Transmitting Antenna | 1 |
| Number of Receiving Antenna | 1 |
| Number of Codes | Serving Cell: 2 |
| | Neighbor Cell: 16 |
| Code ID | Serving Cell: 1, 2 |
| | Neighbor Cell: 1-16 |
| Number of Slots | 1 |
| Wireless Channel | AWGN |
| Signal-to-Noise Ratio | 15 dB |

With the above stimulation parameter configuration and the channel environment, the performance stimulation results of the joint detection are shown by FIG. 5. As can be seen from FIG. 5, as compared with the conventional algorithm, the method or apparatus for code activation according to the embodiments of this invention will bring no performance loss to the joint detection. As compared with the traditional algorithm, the method or apparatus for code activation according to the embodiments of this invention has a probability for reserving 12 active codes of 98%, and a probability for reserving 14 active codes of 2%. According to the conventional algorithm, 16 active codes will be reserved. Thus, the method or apparatus for code activation according to the embodiments of this invention can remarkably reduce the complexity of the joint detection, which is particularly true in the case of a close correlation between the codes.

1-19. (canceled)

20. A method for code activation used for joint detection of at least two codes in a Direct Sequence-Code Division Multiple Access system, wherein the at least two codes include at least one user code and at least one interference code, the method comprising:
calculating, based on a channelization code, a scrambling code and a channel impulse response corresponding to each code, a combined channel impulse response for each code;
calculating, based on the combined channel impulse response, a correlation between each user code and each interference code;
acquiring a statistical result of the correlations between each interference code and all the user codes;
determining a number of active interference codes representing a number of the interference codes to activate; and
activating the determined number of interference codes, wherein a selection of which interference codes to activate is based on the statistical result.

21. The method according to claim 20, wherein the selection comprises:
selecting, in a descending order, the statistical results of the number of active interference codes;
determining interference codes corresponding to the selected statistical results as the interference codes to activate.

22. The method according to claim 20, wherein the calculating the combined channel impulse response comprises:
performing a point multiplication on the channelization code corresponding to each code with the scrambling code corresponding to the code, so as to obtain a first result, the first result being a vector; and
performing a convolution on the first result with the channel impulse response corresponding to the code, so as to obtain the combined channel impulse response for the code.

23. The method according to claim 20, wherein the calculating the correlation comprises:
performing a point multiplication on a conjugation of the combined channel impulse response for each interference code with the combined channel impulse response for each user code, so as to obtain a second result, the second result being a vector;
performing a summation on all elements of the second result, so as to obtain a third result; and
calculating an absolute value of the third result, so as to obtain the correlation between the user code and the interference code.

24. The method according to claim 20, wherein the statistical result is:
a sum value of the correlations between each interference code and all the user codes; or
a mean value of the correlations between each interference code and all the user codes; or
a maximum value of the correlations between each interference code and all the user codes.

25. The method according to claim 20, wherein the determining the number of active interference codes comprises calculating a difference value between a maximum number of codes supported by the joint detection and the number of user codes, so as to obtain the number of active interference codes.

26. The method according to claim 20, wherein the determining the number of active interference codes comprises:
calculating a fluctuation parameter of the correlations between the user codes and each interference code;
acquiring at least two preset continuous numerical ranges, and determining from the at least two continuous numerical ranges, a numerical range to which the fluctuation parameter belongs, the at least two continuous numerical ranges being obtained by dividing a numerical range of the fluctuation parameter, and the numerical ranges being not overlapped with each other;
determining, according to correspondences between the preset numerical ranges and the number of active codes, a third number of active codes corresponding to the numerical range to which the fluctuation parameter belongs, in the correspondences, a fluctuation parameter in a first numerical range being larger than that in a second numerical range, and a first number of active codes corresponding to the first numerical range being less than or equal to a second number of active codes corresponding to the second numerical range;
selecting the larger one of the third number of active codes and the number of user codes as a final number of active codes; and
calculating a difference value between the final number of active codes and the number of user codes, so as to obtain the number of active interference codes.

27. The method according to claim 26, wherein the calculating the fluctuation parameter comprises:
calculating a fluctuation of the correlations between any one of user codes and all interference codes, so as to obtain a first fluctuation parameter; or
selecting at least two of the user codes and acquiring the correlations between the at least two user codes and all interference codes,
performing a weighted summation on the correlations between the at least two user codes and each interference code;
acquiring all the weighted summation results, and
calculating a fluctuation of all the weighted summation results, so as to obtain the first fluctuation parameter.

28. An apparatus for code activation used for joint detection of at least two codes in a Direct Sequence-Code Division Multiple Access system, wherein the at least two codes include at least one user code and at least one interference code, the apparatus comprising:
a combined channel impulse response calculation circuit configured to calculate, according to a channelization code, a scrambling code and a channel impulse response corresponding to each code, a combined channel impulse response for each code;
a correlation calculation circuit configured to calculate, according to the combined channel impulse response, a correlation between each user code and each interference code;
a counting circuit configured to acquire a statistical result of the correlations between each interference code and all the user codes;
a first determination circuit for a number of active interference codes configured to determine a number of active interference codes representing a number of the interference codes to activate; and
an activation circuit configured to activate the determined number of interference codes, wherein a selection of which interference codes to activate is based on the statistical result.

29. The apparatus according to claim 28, wherein the activation circuit comprises:
a selection circuit configured to select, in a descending order, the statistical results of the number of active interference codes; and
a second determination circuit configured to determine interference codes corresponding to the selected statistical results as the interference codes to activate.

30. The apparatus according to claim 28, wherein the combined channel impulse response calculation circuit comprises:
a first point multiplication circuit configured to perform a point multiplication on the channelization code corresponding to each code with the scrambling code corresponding to the code, so as to obtain a first result, the first result being a vector; and
a convolution circuit configured to perform a convolution on the first result with the channel impulse response corresponding to the code, so as to obtain the combined channel impulse response for the code.

31. The apparatus according to claim 28, wherein the correlation calculation circuit comprises:
a second point multiplication circuit configured to perform a point multiplication on a conjugation of the combined channel impulse response for each interference code with the combined channel impulse response for each user code, so as to obtain a second result, the second result being a vector;
a summation circuit configured to perform a summation on all elements of the second result, so as to obtain a third result; and
an absolute value calculation circuit configured to calculate an absolute value of the third result, so as to obtain the correlation between the user code and the interference code.

32. The apparatus according to claim 28, wherein the statistical result is:
a sum value of the correlations between each interference code and all the user codes; or
a mean value of the correlations between each interference code and all the user codes; or
a maximum value of the correlations between each interference code and all the user codes.

33. The apparatus according to claim 28, wherein the determination circuit for the number of active interference codes comprises:
a first difference value calculation circuit configured to calculate a difference value between a maximum number of codes supported by the joint detection and the number of user codes, so as to obtain the number of active interference codes.

34. The apparatus according to claim 28, wherein the determination circuit for the number of active interference codes comprises:
a fluctuation calculation circuit configured to calculate a fluctuation parameter of the correlations between the user codes and each interference code;
a numerical range determination circuit configured to acquire at least two preset continuous numerical ranges, and to determine from the at least two continuous numerical ranges, a numerical range to which the fluctuation parameter belongs, the at least two continuous numerical ranges being obtained by dividing a value range of the fluctuation parameter, and the numerical ranges being not overlapped with each other;
an determination circuit for the number of active codes configured to determine, according to correspondences between the preset numerical ranges and the number of active codes, a third number of active codes corresponding to the numerical range to which the fluctuation parameter belongs, in the correspondences, a fluctuation parameter in a first numerical range being larger than that in a second numerical range, and a first number of active codes corresponding to the first numerical range being less than or equal to a second number of active codes corresponding to the second numerical range;
a first selection circuit configured to select the larger one of the third number of active codes and the number of user codes as a final number of active codes; and
a second difference value calculation circuit configured to calculate a difference value between the final number of active codes and the number of user codes, so as to obtain the number of active interference codes.

35. The apparatus according to claim 34, wherein the fluctuation calculation circuit comprises a first calculation circuit configured to calculate a fluctuation of the correlation between the user codes and each interference code, so as to obtain the fluctuation parameter of the correlations between the user codes and each interference code.

36. The apparatus according to claim 34, wherein the fluctuation calculation circuit comprises:
a second selection circuit configured to select at least two user codes;
a first acquisition circuit configured to acquire the correlations between the at least two user codes and each interference code;
a summation circuit configured to perform a weighted summation on the correlations between the at least two user codes and each interference code;
a second acquisition circuit configured to acquire all the weighted summation results; and
a second calculation circuit configured to calculate a fluctuation of all the weighted summation results, so as to obtain the fluctuation parameter of the correlations between the user codes and each interference code.

37. A computer program product comprising instructions, wherein, when being executed by a processor circuit, configure the processor circuit to:
calculate, based on a channelization code, a scrambling code and a channel impulse response corresponding to each code, a combined channel impulse response for each code;
calculate, based on the combined channel impulse response, a correlation between each of at least one user code and at least one interference code;
acquire a statistical result of the correlations between each of the at least one interference code and all of the at least one user codes;
determine a number of active interference codes representing a number of the interference codes to activate; and
activate the determined number of interference codes, wherein a selection of which interference codes to activate is based on the statistical result.

38. The computer program product according to claim 37, wherein the instructions further configure the processor circuit to:
select, in a descending order, the statistical results of the number of active interference codes;
determine interference codes corresponding to the selected statistical results as the interference codes to activate.

39. The computer program product according to claim 37, wherein to calculate the combined channel impulse response, the instructions configure the processor circuit to:
perform a point multiplication on the channelization code corresponding to each code with the scrambling code corresponding to the code, so as to obtain a first result, the first result being a vector; and
perform a convolution on the first result with the channel impulse response corresponding to the code, so as to obtain the combined channel impulse response for the code.

40. The computer program product according to claim 37, wherein to calculate the correlation, the instructions configure the processor circuit to:
perform a point multiplication on a conjugation of the combined channel impulse response for each interference code with the combined channel impulse response for each user code, so as to obtain a second result, the second result being a vector;
perform a summation on all elements of the second result, so as to obtain a third result; and
calculate an absolute value of the third result, so as to obtain the correlation between the user code and the interference code.

41. The computer program product according to claim 37, wherein the statistical result is:
a sum value of the correlations between each interference code and all the user codes; or
a mean value of the correlations between each interference code and all the user codes; or
a maximum value of the correlations between each interference code and all the user codes.

42. The computer program product according to claim 37, wherein to determine the number of active interference codes, the instructions configure the processor circuit to calculate a difference value between a maximum number of codes supported by the joint detection and the number of user codes, so as to obtain the number of active interference codes.

43. The computer program product according to claim 37, wherein to determine the number of active interference codes, the instructions configure the processor circuit to:
calculate a fluctuation parameter of the correlations between the user codes and each interference code;
acquire at least two preset continuous numerical ranges, and determining from the at least two continuous numerical ranges, a numerical range to which the fluctuation parameter belongs, the at least two continuous numerical ranges being obtained by dividing a numerical range of the fluctuation parameter, and the numerical ranges being not overlapped with each other;
determine, according to correspondences between the preset numerical ranges and the number of active codes, a third number of active codes corresponding to the numerical range to which the fluctuation parameter belongs, in the correspondences, a fluctuation parameter in a first numerical range being larger than that in a second numerical range, and a first number of active codes corresponding to the first numerical range being less than or equal to a second number of active codes corresponding to the second numerical range;
select the larger one of the third number of active codes and the number of user codes as a final number of active codes; and
calculate a difference value between the final number of active codes and the number of user codes, so as to obtain the number of active interference codes.

44. The computer program product according to claim 43, wherein to calculate the fluctuation parameter, the instructions configure the processing circuit to:
calculate a fluctuation of the correlations between any one of user codes and all interference codes, so as to obtain a first fluctuation parameter; or
select at least two of the user codes and acquiring the correlations between the at least two user codes and all interference codes,
perform a weighted summation on the correlations between the at least two user codes and each interference code;
acquire all the weighted summation results, and
calculate a fluctuation of all the weighted summation results, so as to obtain the first fluctuation parameter.

45. A computer-readable storage medium having instructions stored thereon that, when executed by a processor circuit, configure the processor circuit to:
calculate, based on a channelization code, a scrambling code and a channel impulse response corresponding to each code, a combined channel impulse response for each code;
calculate, based on the combined channel impulse response, a correlation between each of at least one user code and at least one interference code;
acquire a statistical result of the correlations between each of the at least one interference code and all of the at least one user codes;
determine a number of active interference codes representing a number of the interference codes to activate; and
activate the determined number of interference codes, wherein a selection of which interference codes to activate is based on the statistical result.
